(19) United States
(12) Patent Application Publication
(10) Pub. No.: US 2011/0048627 A1
(43) Pub. Date: Mar. 3, 2011

(54) METHOD FOR MANUFACTURING DEVICE HOUSING

(75) Inventors: SHUO-HSIU CHANG, Tu-Cheng (TW); WEI DENG, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-CHENG (TW)

(21) Appl. No.: 12/577,924

(22) Filed: Oct. 13, 2009

(30) Foreign Application Priority Data
Sep. 3, 2009 (CN) 200910306541.6

(51) Int. Cl. B29C 45/14

(52) U.S. Cl. 156/245

(57) ABSTRACT

A method for manufacturing a device housing, including attaching an adhesive member on an edge of a glass plate, positioning the glass plate and a metal member in an injection mold, the metal member opposite to the edge of the glass plate, and injecting molten plastic material into the injection mold, thus forming a plastic frame coating the glass plate and the adhesive member by the injection mold.

### CROSS-REFERENCE TO RELATED APPLICATIONS

This application is related to four co-pending U.S. patent applications, application Ser. Nos. [to be determined], with Attorney Docket No. US28910, US28911 and US28913, and all entitled “DEVICE HOUSING,” application Ser. No. [to be determined], with Attorney Docket No. US28912, and entitled “FASTENER AND DEVICE HOUSING USING THE SAME.” The co-pending applications have the same assignee as the present application.

### BACKGROUND

1. Technical Field

The present disclosure relates generally to device housings and, more particularly, to a method for manufacturing a device housing for an electronic devices.

2. Description of Related Art

With developments in technology, electronic devices such as mobile phones are not only required to perform many functions, but also provide an appearance appealing to the user.

Referring to FIGS. 9 and 10, a frequently used housing 10 for a mobile phone 10 includes a frame 11 and a glass plate 12 received therein. The frame 11 is substantially rectangular, and forms a positioning portion 113 on an inner surface. During assembly of the device housing 10, the adhesive 20 is coated on the positioning portion 113. The glass plate 12 is received in the frame 11, and attached to the positioning portion 113. Thus, the glass plate 12 and the frame 11 are glued together. The adhesive 20 is generally epoxy resin glue, which can only be used once.

However, a gap may form between the glass plate 12 and the frame 11, out of which the adhesive 20 may overflow, affecting appearance. Furthermore, the adhesive 20 may not uniformly cover the positioning portion 113, such that a top surface of the glass plate 12 may misalign with a top surface of the frame 11. The appearance of the device housing 10 is again affected.

Therefore, a method for manufacturing a device housing overcoming the described limitations is desirable.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a first embodiment of a device housing manufactured by a first embodiment of a method for manufacturing the device housing.

FIG. 2 is an exploded, isometric view of the device housing of FIG. 1.

FIG. 3 is a cross-section of the device housing of FIG. 1 taken along line

FIG. 4 shows the device housing of FIG. 1 manufactured by an injection mold.

FIG. 5 is an isometric view of a second embodiment of a device housing manufactured by a second embodiment of a method for manufacturing housing.

FIG. 6 is an exploded, isometric view of the device housing of FIG. 5.

FIG. 7 is a cross-section of the device housing of FIG. 5 taken along line VII-VII.

FIG. 8 shows the device housing of FIG. 5 manufactured by an injection mold.

FIG. 9 is an isometric view of a typical housing.

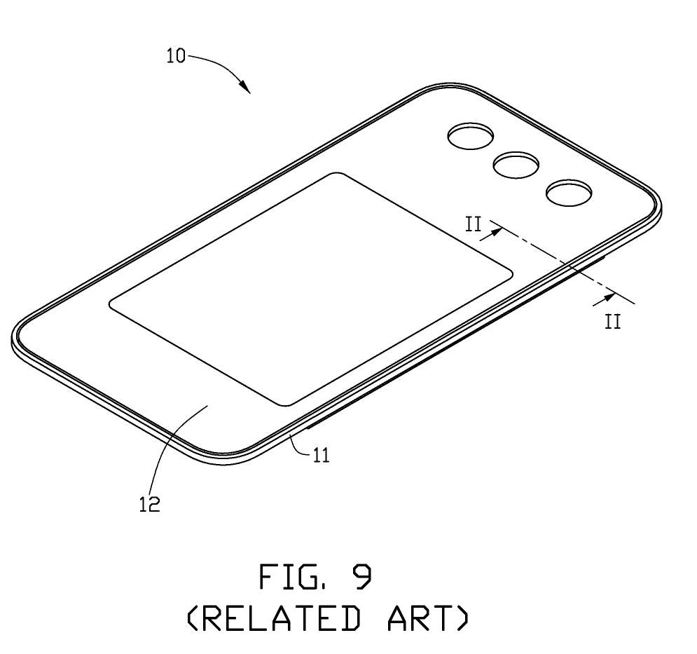

FIG. 10 is a cross-section of the device housing of FIG. 9 taken along line II-II.

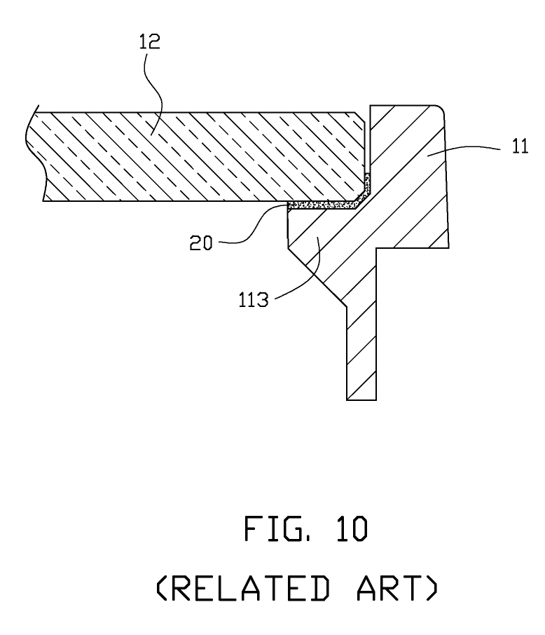

### DETAILED DESCRIPTION

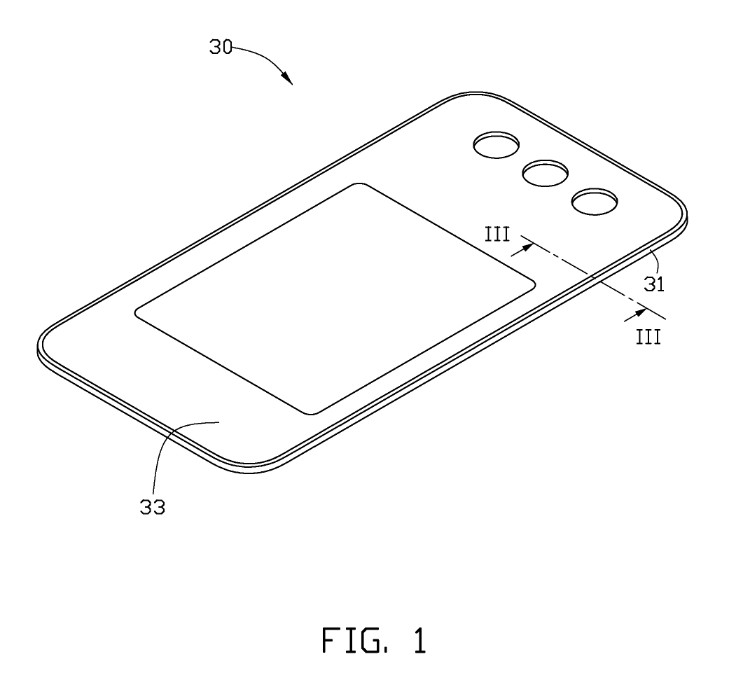

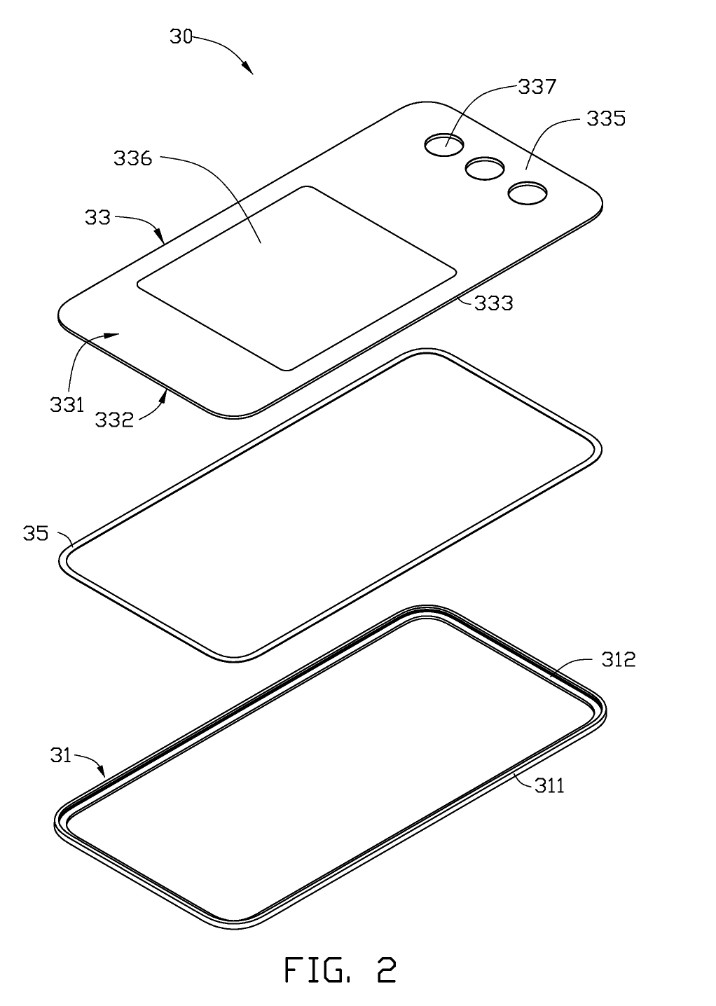

Referring to FIGS. 1 through 3, a first embodiment of a method for manufacturing a first embodiment of a device housing 30 is provided. The device housing 30 is integrally formed by a plastic frame 31, a glass plate 33, and an adhesive member 35. In the illustrated embodiment, the device housing 30 is used for an electronic device (not shown).

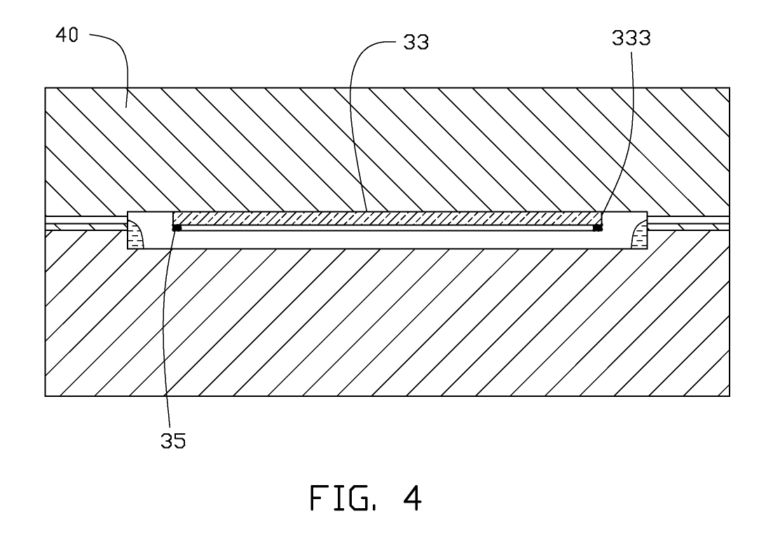

The plastic frame 31 includes a side frame 311 and an annular positioning portion 312 formed on an inner surface of the side frame 311. The plastic frame 31 is formed by an injection mold 40 (as shown in FIG. 4). In the illustrated embodiment, the side frame 311 is substantially rectangular. The plastic frame 31 comprises nylon and fiberglass.

The glass plate 33 includes a first surface 331, a second surface 332 opposite to the first surface 331, and a side surface 333 connecting the first surface 331 with the second surface 332. A periphery of the first surface 331 is coated with printing ink to form a light shielding portion 335 and a light guiding portion 336 surrounded by the light shielding portion 335. An end of the glass plate 33 defines three assembling holes 337 arranged side by side. A chamfer angle 338 formed on an edge of the first surface 331 and the second surface 332 strengthens the glass plate 33 considerably. In the illustrated embodiment, the glass plate 33 is substantially rectangular.

The adhesive member 35 is polyurethane glue in this embodiment. The polyurethane glue can be liquefied to provide adhesion in damp and high temperature conditions, above about 60° C., and solidified to provide adhesion in dry and normal temperature conditions. Thus, the adhesive member 35 can be used repeatedly. In the illustrated embodiment, the adhesive member 35 is substantially a rectangular ring corresponding to the positioning portion 312 of the plastic frame 31.

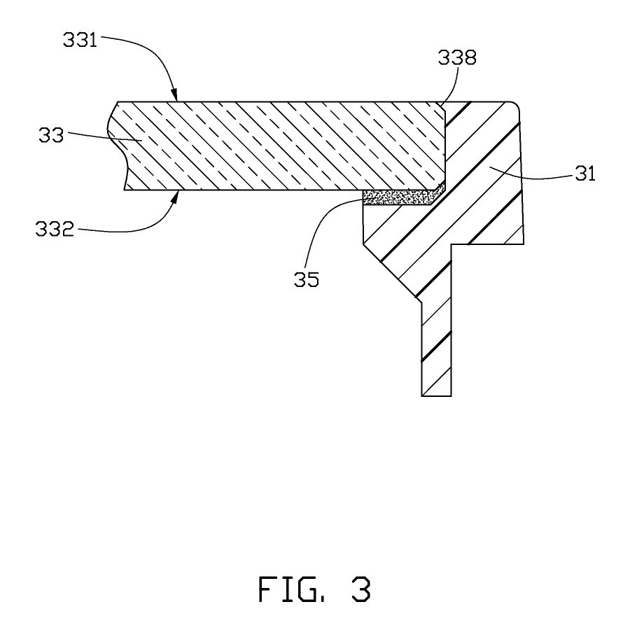

Referring to FIGS. 3 and 4, the device housing 30 can be integrally formed by molding as follows: printing the adhesive member 35 on the edge of the glass plate 33 and drying the adhesive member 35; positioning the glass plate 33 in the injection mold 40; injecting molten plastic material to the side surface 333 of the glass plate 33 to form the plastic frame 31 by the injection mold 40, the adhesive member 35 providing adhesion; and cooling the device housing 30, wherein the adhesive member 35 is sandwiched between the plastic frame 31 and the glass plate 33.

Since the plastic frame 31 and the glass plate 33 are integrally formed via the injection mold 40, there is no gap between the plastic frame 31 and the glass plate 33, and a top surface of the glass plate 33 aligns with a top surface of the plastic frame 31. Thus, the device housing 30 provides a good appearance. In addition, the adhesive member 35 is printed on the glass plate 33, and the device housing 30 is integrally formed, with manufacturing efficiency greatly enhanced.

It should be pointed out that the plastic frame 31 and the glass plate 33 may be other shapes, for example, the glass plate 33 may be an ellipse, and the plastic frame 31 an ellipsular ring. The chamfer angle 338 may be formed on only an edge of the first surface 331 or the second surface 332. In addition, the adhesive member 35 can be positioned on the edge of the glass plate 33 by other means, such as smearing. A temperature of the injection mold 40 is preferably above about 60° C. when the molten plastic material is injected.

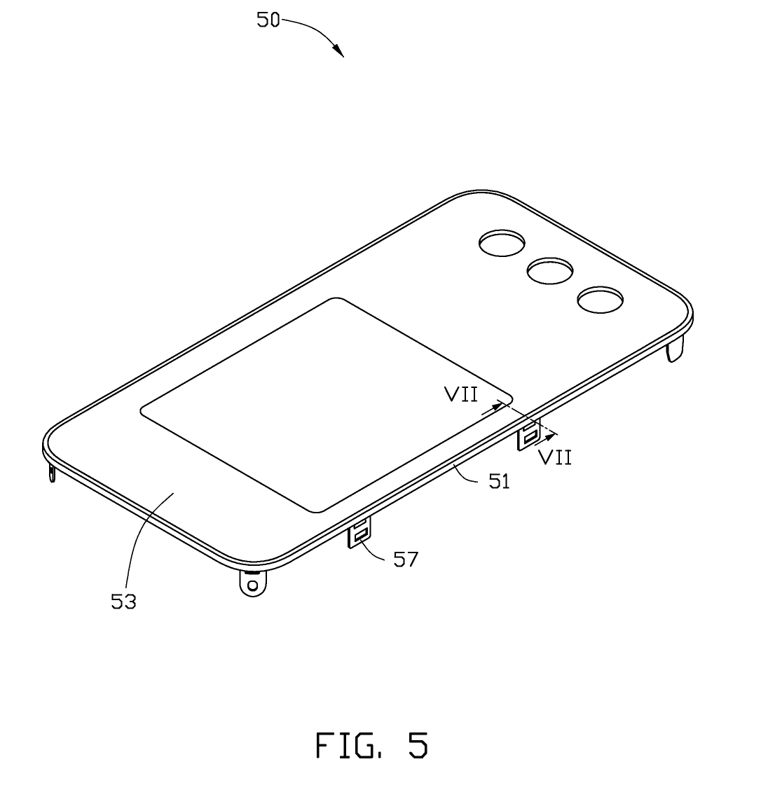

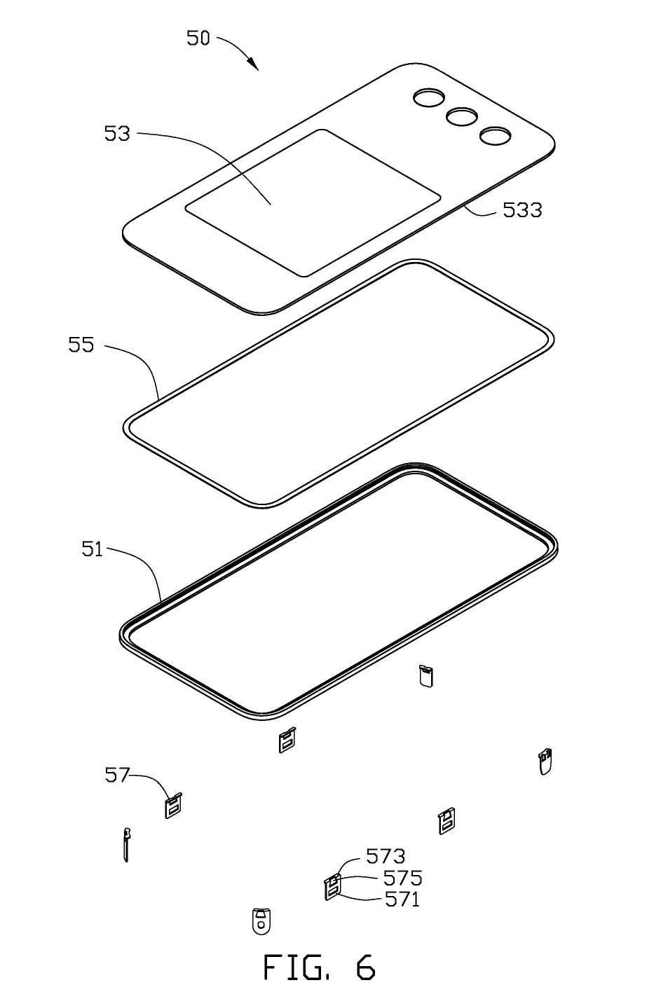

Referring to FIGS. 5 through 7, a second embodiment of a method for manufacturing a second embodiment of device housing 50 is provided. The device housing 50 is integrally formed by a plastic frame 51, a glass plate 53, an adhesive member 55, and a plurality of metal members 57. The plastic frame 51, the glass plate 53, and the adhesive member 55 are structured similar to the first embodiment of a plastic frame 31, the glass plate 33, and the adhesive member 35 of the device housing 30. In the illustrated embodiment, the metal members 57 are stainless steel.

Each metal member 57 includes a main body 571 and a hook portion 573 extending from an end of the main body 571. Each metal member 57 defines one or more connecting holes 575. The connecting hole 575 allows molten plastic material therethrough during injection. The connecting holes 575 are filled with plastic material after the molten plastic material is cooled.

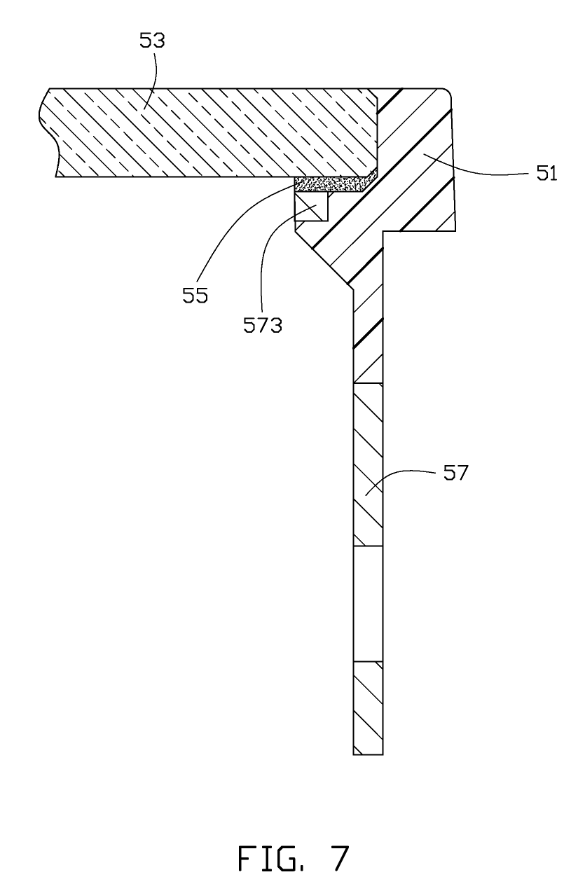

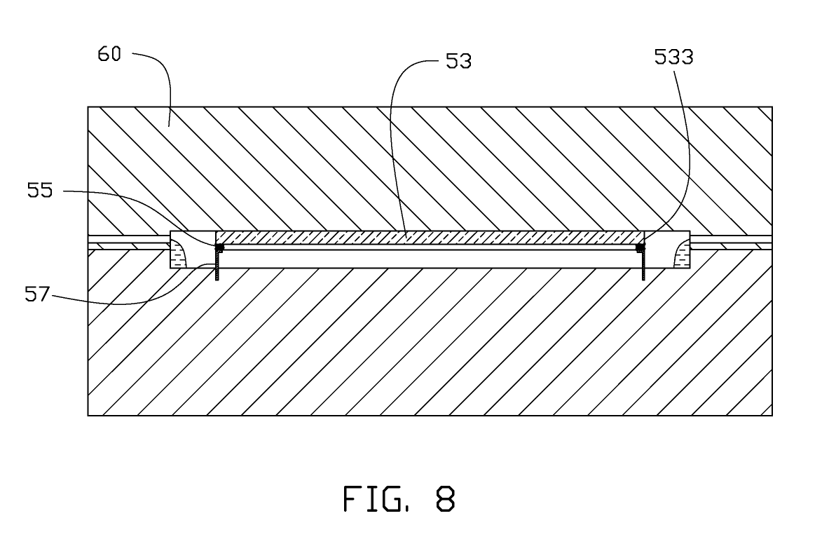

Referring to FIGS. 7 and 8, the device housing 50 can be integrally formed by molding as follows: printing the adhesive member 55 on the edge of the glass plate 53 and drying the adhesive member 55; positioning the glass plate 53 and the metal members 57 in an injection mold 60, the metal members 57 corresponding to the edge of the glass plate 53, and the hook portion 573 attached to the adhesive member 55; injecting molten plastic material to the side surface 533 of the glass plate 53 and the metal members 57 to form the plastic frame 51 by the injection mold 60, the adhesive member 55 providing adhesion; and cooling the device housing 50, wherein the plastic frame 51 connects the glass plate 53 and the metal members 57, and the adhesive member 55 is sandwiched between the plastic frame 51, the glass plate 53, and the metal members 57. The device housing 50 provides an unspoiled appearance, and is easily manufactured. The metal members 57 can also engage with other components of the electronic device.

In an alternative embodiment, the metal members 57 can be positioned in the injection mold with a certain distance between the adhesive member 55 and the metal members 57.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A method for manufacturing a device housing, comprising:
attaching an adhesive member on an edge of a glass plate;
positioning the glass plate in an injection mold; and
injecting molten plastic material into the injection mold, thus forming a plastic frame coating on the glass plate and the adhesive member by the injection mold.

2. The method for manufacturing a device housing of claim 1, wherein the adhesive member is printed on the edge of the glass plate.

3. The method for manufacturing a device housing of claim 1, wherein the adhesive member is polyurethane glue.

4. The method for manufacturing a device housing of claim 3, wherein after the adhesive member is attached to the edge of a glass plate, the adhesive member is dried; upon injection of molten plastic material into the injection mold, the adhesive member is liquefied to provide adhesion again.

5. The method for manufacturing a device housing of claim 1, wherein the plastic frame comprises a side frame and an annular positioning portion formed on an inner surface of the side frame on which the glass plate is located and surrounded by the side frame.

6. The method for manufacturing a device housing of claim 5, wherein the adhesive member is glued to the positioning portion of the plastic frame.

7. The method for manufacturing a device housing of claim 1, wherein the plastic frame is comprised of nylon and fiberglass.

8. The method for manufacturing a device housing of claim 1, wherein a temperature of the injection mold is above about 60° C. when the molten plastic material is injected.

9. A method for manufacturing a device housing, comprising:
attaching an adhesive member on an edge of a glass plate;
positioning the glass plate and a metal member in an injection mold, the metal member opposite to the edge of the glass plate; and
injecting molten plastic material to the glass plate and the metal member by the injection mold, thus forming a plastic frame connecting the glass plate and the metal member, and sandwiching the adhesive member between the plastic frame and the glass plate.

10. The method for manufacturing a device housing of claim 9, wherein the metal member is glued to the adhesive member.

11. The method for manufacturing a device housing of claim 9, wherein the adhesive member is printed on the edge of the glass plate.

12. The method for manufacturing a device housing of claim 9, wherein the adhesive member is polyurethane glue.

13. The method for manufacturing a device housing of claim 12, wherein after the adhesive member is attached to the edge of a glass plate, the adhesive member is dried; upon injection of molten plastic material into the injection mold, the adhesive member is liquefied to provide adhesion again.

14. The method for manufacturing a device housing of claim 9, wherein the plastic frame comprises a side frame and an annular positioning portion formed on an inner surface of the side frame, on which the glass plate is located and surrounded by the side frame.

15. The method for manufacturing a device housing of claim 14, wherein the adhesive member is glued to the positioning portion of the plastic frame.

16. The method for manufacturing a device housing of claim 9, wherein the plastic frame is comprised of nylon and fiberglass.

17. The method for manufacturing a device housing of claim 9, wherein a temperature of the injection mold is above about 60° C. when the molten plastic material is injected.

18. The method for manufacturing a device housing of claim 9, wherein the metal member is stainless steel.

19. The method for manufacturing a device housing of claim 9, wherein each metal member comprises a main body and a hook portion extending from an end of the main body, the hook portion engaging with the plastic frame.

20. The method for manufacturing a device housing of claim 19, wherein the metal member defines at least one connecting hole, through which molten plastic material flows during injection, and which is filled with plastic material after the molten plastic material is cooled.
